(19) United States
(12) Patent Application Publication
(10) Pub. No.: US 2007/0018913 A1
(43) Pub. Date: Jan. 25, 2007

(54) Plasma display panel, plasma display device and driving method therefor

(76) Inventors: Sang-Hoon Yim, Yongin-si (KR); Yoon-Hyoung Cho, Chunan-si (KR); Su-Yong Chae, Suwon-si (KR); Tae-Woo Kim, Dongjak-gu (KR)

Correspondence Address: LEE & MORSE, P.C., 3141 FAIRVIEW PARK DRIVE, SUITE 500, FALLS CHURCH, VA, 22042, US

(21) Appl. No.: 11/489,530

(22) Filed: Jul. 20, 2006

(30) Foreign Application Priority Data
Jul. 21, 2005 (KR) 10-2005-0066247
Nov. 24, 2005 (KR) 10-2005-0112858

(51) Int. Cl. G09G 3/28

(52) U.S. Cl. 345/67

(57) ABSTRACT

A plasma display device including a plasma display panel having a plurality of discharge cells defined between a front substrate and a rear substrate, address electrodes proximate to the discharge cells and extending in a first direction, and scan and sustain electrodes proximate to the discharge cells and extending in a second direction crossing the first direction, wherein, for a same pixel, at least two discharge cells of different colors correspond to a same address electrode.

### BACKGROUND OF THE INVENTION

1. Field of the Invention

The present invention relates to a plasma display panel, a plasma display device and a driving method therefor. More particularly, the present invention relates to a plasma display panel and a plasma display device having an enhanced arrangement of pixels and electrodes that enables a high integration of pixels, and a driving method therefor.

2. Description of the Related Art

Generally, a plasma display device includes a plasma display panel (PDP) that excites phosphors with vacuum ultraviolet light radiated from a plasma generated through gas discharge. The PDP displays desired images using visible light, e.g., red (R), green (G) and blue (B) light, generated by the excited phosphors. Plasma display devices are attractive solutions for flat panel displays, e.g., televisions, industrial displays, etc., due to their unique advantages. Plasma display devices can be manufactured in very large screen sizes, e.g., 60 inches or more, while having a relatively small thickness, e.g., 10 cm or less. Plasma display devices may also exhibit excellent color reproduction, and, since they are self-emissive displays like a cathode ray tubes, may offer large viewing angles without image distortion. Additionally, the manufacture of PDPs may be achieved with higher productivity and lower production costs than other display elements such as those used in liquid crystal displays.

One type of PDP is a three-electrode surface-discharge PDP. The three-electrode surface-discharge PDP may include a first substrate having sustain electrodes and scan electrodes on a same surface, and a second substrate disposed apart from the first substrate by a predetermined distance and having address electrodes disposed thereon, the address electrodes extending perpendicular to the sustain and scan electrodes. A discharge gas may be filled in discharge cells between the two substrates of the PDP.

For each discharge cell of the PDP, a discharge in the discharge cell may be controlled by a discharge between a scan electrode and a corresponding address electrode. A sustain discharge that actually displays a required image may be controlled by the sustain electrode and scan electrode.

FIG. 5 illustrates a plan view of an arrangement of pixels and electrodes in a conventional PDP. It will be understood that FIG. 5 illustrates only part of the display area of the PDP, and the indices n and m in FIG. 5 may indicate arbitrary integers. Referring to FIG. 5, the PDP may include a delta-shaped rib structure, wherein discharge cells, i.e., separate spaces, are partitioned by barrier ribs of the rib structure. The PDP may include a pixel 71 that includes three adjacent discharge cells 71R, 71G and 71B that are arranged in a triangular pattern. The discharge cells 71R, 71G and 71B may emit, respectively, red, green and blue colored light.

The PDP may include address electrodes 75, which may be arranged to cross the discharge cells 71R, 71G and 71B of the pixel 71. For pixel 71, three address electrodes 75 may be provided, each address electrode 75 corresponding to one of discharge cells 71R, 71G and 71B. That is, pixel 71 may be served by three address electrodes 75. As illustrated in FIG. 5, sixteen pixels 71 require twelve address electrodes 75 in total, i.e., address electrodes Am, Am+1, . . . , Am+11, since the pixels are offset. That is, in FIG. 5, four pixels are arranged in each row and each pixel requires three address electrodes.

The PDP may also include scan electrodes Yn . . . Yn+3, and sixteen pixels 71 may require four scan electrodes Y. Similarly, the PDP may include sustain electrodes Xn . . . Xn+3, and sixteen pixels 71 may require four sustain electrodes X.

For a same display area, discharge cells must be arranged more densely if the resolution of the PDP is to be increased. Consequently, adjacent address electrodes 75 must be disposed closer together, which may increase power consumption. In particular, capacitance between adjacent address electrodes may increase as the address electrodes are moved closer together, resulting in increased power consumption by the PDP, where power consumption is calculated as CV²f, C is capacitance, V is voltage and f is frequency.

The information disclosed above in the Background section is provided only for the purpose of aiding and enhancing an understanding of the basis and background of the present invention, and does not constitute, and is not to be interpreted as, an admission or statement as to what is or is not considered or constitutes prior art relative to the present invention.

### SUMMARY OF THE INVENTION

The present invention is therefore directed to a plasma display panel, a plasma display device and a driving method therefor, which substantially overcome one or more of the problems due to the limitations and disadvantages of the related art.

It is therefore a feature of an embodiment of the present invention to provide a plasma display panel and a plasma display device employing a reduced number of address electrodes per pixel, thereby reducing costs and allowing a higher display resolution.

It is therefore another feature of an embodiment of the present invention to provide a plasma display panel and a plasma display device having pixels of different colors associated with a same address electrode.

It is therefore still another feature of an embodiment of the present invention to provide a method of driving a plasma display panel that may reduce the need for switching an address electrode, thereby reducing power address electrode power consumption.

At least one of the above and other features and advantages of the present invention may be realized by providing a plasma display device including a plasma display panel including a plurality of discharge cells defined between a front substrate and a rear substrate, address electrodes proximate to the discharge cells and extending in a first direction, and scan and sustain electrodes proximate to the discharge cells and extending in a second direction crossing the first direction, wherein, for a same pixel, at least two discharge cells of different colors correspond to a same address electrode.

Centers of three discharge cells forming the same pixel may be arranged in a triangular pattern, and 3/2 scan electrodes may correspond to the pixel. The plasma display device may further include scan electrode drivers connected to the scan electrodes, wherein first scan electrodes corresponding to discharge cells of a same color along a same address electrode may be connected to a same scan electrode driver. The scan and sustain electrodes may be alternately arranged in the first direction, and the first scan electrodes may be arranged every three scan electrodes in the first direction. There may be first, second and third colors of discharge cells and corresponding first, second and third scan electrode drivers. A same scan electrode driver may be configured to apply scan signals to the first scan electrodes sequentially, such that discharge cells of a first color along the same address electrode may be scanned before discharge cells of a second color along the same address electrode are scanned.

A number Ai of address electrodes and a number Yj of scan electrodes in a p×p array of pixels may satisfy Equation 1:
Ai:Yj=4:3 (1),

where p is a positive integer representing the number of pixels continuously arranged in the first or second direction. For p=4, eight address electrodes and six scan electrodes may drive all of the pixels in the p×p array of pixels.

Each of the discharge cells may have a hexagonal plan shape. Each of the discharge cells may have a rectangular plan shape. A borderline between a pair of discharge cells that are adjacent along a same address electrode may extend perpendicular to the address electrode. There may be first, second and third colors of discharge cells and a same address electrode may cross near a center of a first discharge cell of the first color, near a center of a second discharge cell of the second color and a near a center of a third discharge cell of the third color in sequence. The first and second discharge cells may be part of a same pixel, the third discharge cell may be part of an adjacent pixel, the first discharge cell may be crossed by a first scan electrode and the second discharge cell may be crossed by a second scan electrode.

At least one of the above and other features and advantages of the present invention may also be realized by providing a method of driving a plasma display device, the plasma display device including address electrodes and scan electrodes configured to drive discharge cells in a pixel, wherein, in the pixel, discharge cells of a first color and discharge cells of a second color are disposed along a given address electrode, the method including applying scan signals to scan electrodes corresponding to discharge cells of the first color along the first address electrode during a first portion of an address period of the given address electrode, and applying scan signals to scan electrodes corresponding to discharge cells of the second color along the first address electrode during a subsequent portion of the address period.

The scan signals may be sequentially applied to the scan electrodes corresponding to a same color along the given address electrode. The method may further include applying scan signals to scan electrodes corresponding to the discharge cells of a third color along the given address electrode during a third portion of the address period. The scan signals may be sequentially applied to the scan electrodes corresponding to the third color. The plasma display device may include a plurality of scan electrodes that cross the given address electrode, and scan signals may be applied sequentially to every third scan electrode.

At least one of the above and other features and advantages of the present invention may further be realized by providing a plasma display panel including an array of pixels, each pixel including three different colored subpixels, and a plurality of address electrodes and a plurality of scan electrodes configured to drive the array, wherein each address electrode is configured to drive subpixels of each of the three different colors, a same address electrode is configured to drive two different colored subpixels of a same pixel, and a same scan electrode is configured to drive two different colored pixels of a same pixel.

For a same pixel, each of the three subpixels may be driven by one of two adjacent address electrodes and one of two adjacent scan electrodes.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates a schematic diagram of an exemplary plasma display device according to a first embodiment of the present invention;

FIG. 2 illustrates an exploded perspective view of an exemplary plasma display panel according to the first embodiment of the present invention;

FIG. 3 illustrates a schematic diagram of an exemplary plasma display device according to a second embodiment of the present invention;

FIG. 4 illustrates a driving method of a plasma display device according to a third embodiment of the present invention; and

FIG. 5 illustrates a schematic diagram of a conventional PDP.

### DETAILED DESCRIPTION OF THE INVENTION

Korean Patent Application No. 10-2005-0066247, filed on Jul. 21, 2005, in the Korean Intellectual Property Office and entitled “Plasma Display Device,” and Korean Patent Application No. 10-2005-0112858, filed on Nov. 24, 2005, in the Korean Intellectual Property Office and entitled “Plasma Display Device and Driving Method Thereof,” are incorporated by reference herein in their entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. It will also be understood that the term “phosphor” is intended to generally refer to a material that can generate visible light upon excitation by ultraviolet light that impinges thereon, and is not intended be limited to materials the undergo light emission through any particular mechanism or over any particular time frame.

In addition, it will also be understood that when an element is connected to another element, it can be directly connected to the other element, or it may be electrically connected to the other element with intervening elements therebetween. In addition, it will also be understood that when a part includes a constituent element, it may further include other constituent elements as well as the constituent element, unless otherwise stated. Like reference numerals refer to like elements throughout.

In a plasma display device according to an embodiment of the present invention, two address electrodes may correspond to each pixel. Accordingly, the number of address electrodes corresponding to each pixel may be reduced, thereby minimizing an increase of address power consumption for a PDP of higher resolution.

In addition, as the number of address electrodes is reduced, the number of address elements connected to address electrodes may also be reduced. Thus, total cost of drive circuits for a PDP may be reduced.

Further, the scan electrodes corresponding to subpixels of a same color with respect to a same address electrode may be successively connected to separate scan electrode drivers. Accordingly, switching of the address electrode may be reduced when a vertical line of single color is displayed, which may reduce address power consumption.

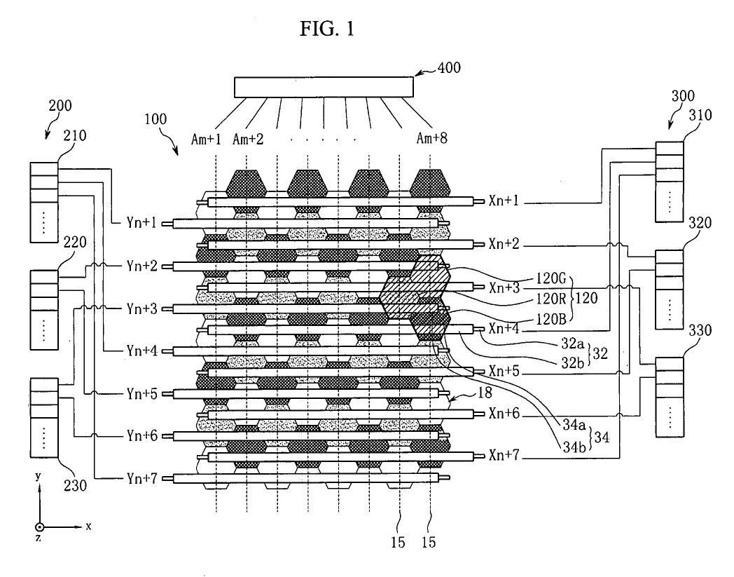

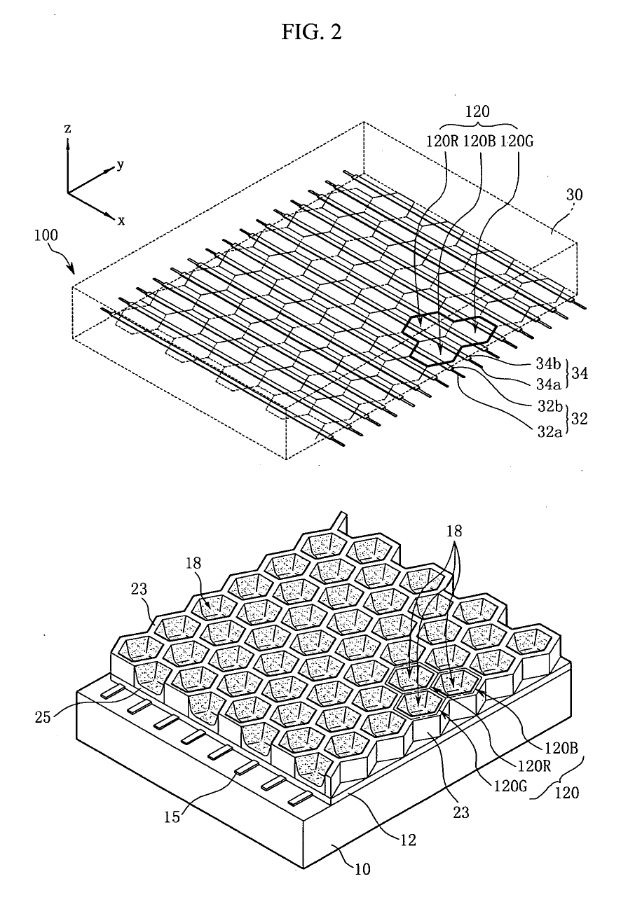

FIG. 1 illustrates a schematic diagram of an exemplary plasma display device according to a first embodiment of the present invention, and FIG. 2 illustrates an exploded perspective view of an exemplary plasma display panel according to the first embodiment of the present invention. Referring to FIG.1, a plasma display device may include a PDP 100, scan electrode drivers 200, sustain electrode drivers 300 and an address electrode driver 400. The scan electrode drivers 200, the sustain electrode drivers 300 and the address electrode driver 400 may be connected to corresponding scan, sustain and address electrodes 34, 32 and 15, respectively.

The PDP 100 may be a “delta arrangement” cell PDP, in which three subpixels of a first color, a second color, and a third color in each pixel are arranged in a triangular pattern. The first color, the second color and the third color may be red, green and blue, respectively.

Referring to FIG. 2, the PDP may include a rear substrate 10 and a front substrate 30 disposed substantially in parallel and combined together with a predetermined space therebetween. Barrier ribs 23 having a predetermined height and pattern and defining pixels 120 may be formed between the rear substrate 10 and the front substrate 30. A pixel 120 may include three subpixels 120R, 120G and 120B in the delta, or triangular, arrangement. The subpixels 120R, 120G and 120B may also be defined by the barrier ribs 23. The subpixels 120R, 120G and 120B may each correspond to a discharge cell 18.

The respective subpixels 120R, 120G and 120B may have a generally hexagonal plan shape, and the barrier ribs 23 defining them may be arranged in a hexagonal or honeycomb pattern. Therefore, each discharge cell 18 of the respective subpixels 120R, 120G and 120B may have the shape of a hexagonal prism that is open at its top, such that the discharge cells 18 have borders on six sides. Two discharge cells that are directly adjacent to each other in the first direction may share a border that, if extended as a hypothetical line, would extend in the second direction, substantially normal to the first direction. The extended line would thus cross centers of discharge cells 18 that are adjacent to the pixel 120 in the second direction. That is, a borderline between a pair of discharge cells 18 that are adjacent along a same address electrode 15 may extend perpendicular to the address electrode 15.

The discharge cells 18 may be provided with a plasma gas including xenon (Xe), neon (Ne), etc., for the plasma discharge. Phosphor layers 25, which may include, e.g., red-, green- and blue-light emitting phosphors, may be disposed in the subpixels 120R, 120G and 120B, respectively, in order to generate red, green and blue colored visible light. The phosphor layers 25 may be formed at bottoms of the discharge cells 18 and on sides of the barrier ribs 23.

The address electrodes 15 may be formed on the rear substrate 10 and may extend along a first direction, e.g., the y-axis direction in the drawing. The address electrodes 15 may be arranged in parallel to one another along a second direction, e.g., the x-axis direction. The address electrodes 15 may be disposed to cross the discharge cells 18, e.g., at an end thereof. The address electrodes 15 may be disposed between the rear substrate 10 and the barrier ribs 23.

A dielectric layer 12 may cover the address electrodes 15. The dielectric layer 12 may be disposed on an entire surface of the rear substrate 10 and may be disposed between the rear substrate 10 and the barrier ribs 23.

Sustain electrodes 32 and scan electrodes 34 may be disposed on the front substrate 30 and may extend in the second direction. The sustain electrodes 32 and the scan electrodes 34 may be formed in a stripe pattern. Pairs of sustain electrodes 32 and scan electrodes 34 may correspond to respective discharge cells 18, the pairs of electrodes separated by discharge gaps in the corresponding discharge cells 18. The sustain electrodes 32 and the scan electrodes 34 may be alternately arranged in the first direction, e.g., the y-axis direction.

Each sustain electrode 32 may include a bus electrode 32a and a transparent electrode 32b, and each scan electrode 34 may include a bus electrode 34a and a transparent electrode 34b. The bus electrodes 32a and 34a may extend in the second direction. The bus electrodes 32a and 34a may be formed of a metallic material having good conductivity. In order to maximize the emission of visible light generated in the discharge cells 18 during the operation of the PDP, the widths of the bus electrodes 32a and 34a may be minimized, within the limits allowed by the conductivity of the bus electrodes 32a and 34a.

The transparent electrodes 32b and 34b may be wider than the bus electrodes 32a and 34a, as determined in the first direction, and may extend in the second direction covering the bus electrodes 32a and 34a. The transparent electrodes 32b and 34b may be formed of a transparent material, e.g., indium-tin-oxide (ITO). A pair of transparent electrodes 32b and 34b may be disposed facing each other in each discharge cell 18, with a predetermined gap therebetween.

A dielectric layer (not shown) may be disposed on the front substrate 30 to cover the sustain electrodes 32 and the scan electrodes 34. The dielectric layer may be disposed on an entire surface of the front substrate 30 and a protective layer (not shown) of, e.g., MgO, may be further disposed thereon.

Further details of the arrangement of pixels and electrodes in the exemplary plasma display according to the first embodiment of the present invention will now be described. Referring again to FIG. 1, two address electrodes 15 may correspond to each pixel 120 and each pixel 120 may include the three subpixels 120R, 120G and 120B, which may emit red, green and blue colored light, respectively. Centers of the three subpixels 120R, 120G and 120B of a same pixel 120 may be arranged in a triangular pattern.

Two of the three discharge cells 18 forming the pixel 120, i.e., two of the three subpixels 120R, 120G and 120B, may be disposed adjacent to each other in the first direction, e.g., in the y-axis direction, and may correspond to a same address electrode 15. The two subpixels 120G and 120B corresponding to the same address electrode 15 may have phosphor layers 25 of different colors. This arrangement may increase the number of discharge cells 18 in the first direction. Accordingly, this arrangement may enhance a margin.

Two scan electrodes 34 may be disposed in the pixel 120. Thus, the individual discharge of each of the three subpixels 120R, 120G and 120B of the pixel 120 may determined by two address electrodes 15 and two scan electrodes 34.

In detail, as described above, one of the two address electrodes 15 disposed in each pixel 120 may be disposed to cross two discharge cells 18 of the pixel 120 that are adjacent to each other in the first direction, e.g., two subpixels 120G and 120B. The other of the two address electrodes 15 may be disposed to cross the remaining discharge cell 18 of the pixel 120, e.g., the subpixel 120R.

The scan electrodes 34 and the sustain electrodes 32 may be alternately arranged along the address electrode 15, and each of them may control the discharge of the discharge cells 18. One of the two scan electrodes 34, e.g., Yn+3, disposed in the pixel 120 may be disposed to cross two discharge cells 18 of the pixel 120 that are adjacent to each other in the second direction, e.g., two subpixels 120R and 120B. Thus, a common voltage may be applied to the two subpixels 120R and 120B of the pixel 120. The two discharge cells 18 of the pixel 120 that have the same scan electrode 34, e.g., subpixels 120R and 120B having electrode Yn+3, may have phosphor layers 25 of different colors. The other of the two scan electrodes corresponding to the pixel 120, e.g., Yn+2, may be disposed to cross the remaining discharge cell 18 of the pixel 120, e.g., the subpixel 120G.

As pairs of scan electrodes 34 and the sustain electrodes 32 correspond to respective discharge cells 18, two sustain electrodes 32, e.g., Xn+3 and Xn+4, may be similarly disposed in the pixel 120. The two sustain electrodes 32 in the pixel 120, e.g., Xn+3 and Xn+4, and the two scan electrodes 34 in the pixel 120, e.g., Yn+2 and Yn+3, may be disposed to face each other in the pixel 120. For each pair of scan electrodes 34 in the pixel 120, one scan electrode 34 may cross one of the subpixels 120R, 120G and 120B, and the other scan electrode 34 may cross the other of the two subpixels 120R, 120G and 120B. Similarly, for each pair of sustain electrodes 32 in the pixel 120, one sustain electrode 32 may cross one of the subpixels 120R, 120G and 120B, and the other sustain electrode 32 may cross the other of the two subpixels 120R, 120G and 120B.

For example, the sustain electrode Xn+4 may be disposed facing the scan electrode Yn+3 across the subpixel 120B in the pixel 120. The sustain electrode Xn+3 may correspond to the two remaining subpixels 120R and 120G in the pixel 120, and may apply a common voltage to the two subpixels 120R and 120G. The sustain electrode Xn+3 may be arranged between the scan electrode Yn+3 and the scan electrode Yn+2 along the first direction.

The sustain electrodes 32 and the scan electrodes 34 corresponding to a pixel 120 may be arranged in the aforementioned way or in a different way, according to the particular arrangement of the pixels 120.

In the exemplary arrangement of pixels and electrodes illustrated in FIG. 2, a pattern of sixteen pixels 120, i.e., four columns of pixels 120 arranged in the second direction and four rows of pixels 120 arranged in the first direction, may be driven by eight address electrodes 15, six scan electrodes 34 and six sustain electrodes 32 crossing the sixteen pixels 120 (the sustain electrode Xn+7 and the scan electrode Yn+7 are not counted).

Thus, conceptually, there are two address electrodes 15 for each pixel 120, i.e., eight address electrodes per four pixels 120 in a row, and one and a half (3/2) scan electrodes 34 per pixel 120, i.e., six scan electrodes per four pixels 120 in a column. Similarly, there are one and a half sustain electrodes 32 per pixel 120.

Accordingly, two address electrodes 15 and one and a half scan electrodes 34 correspond to each pixel 120 for a p×p arrangement of pixels 120 (where p is a positive integer that represents the number of pixels 120 consecutively arranged in the first or second direction). That is, the number Ai of address electrodes 15 and the number Yj of scan electrodes 34 satisfies the ratio of Equation 1:
Ai:Yj=4:3 (Equation 1)

Referring the exemplary PDP illustrated in FIG. 1, a total of eight address electrodes 15, i.e., Am+1 . . . Am+8, correspond to the four columns of pixels 120 shown in FIG. 1. In addition, a total of six scan electrodes 34, i.e., Yn+1 . . . Yn+6, correspond to the four rows of pixels 120 shown in FIG. 1. Similarly, a total of six sustain electrodes 32, i.e., Xn+1 . . . Xn+6, correspond to the four rows of pixels 120.

In the above-described arrangement of pixels and electrodes, two adjacent subpixels 120G and 120B corresponding to a same address electrode 15 have phosphor layers 25 of different colors. Thus, subpixels having phosphor layers 25 of the three different colors may be alternately arranged on the same address electrode 15. That is, for a same address electrode 15, the sequence of phosphor layers 25 may be, e.g., blue, green, red, blue, green, red, etc.

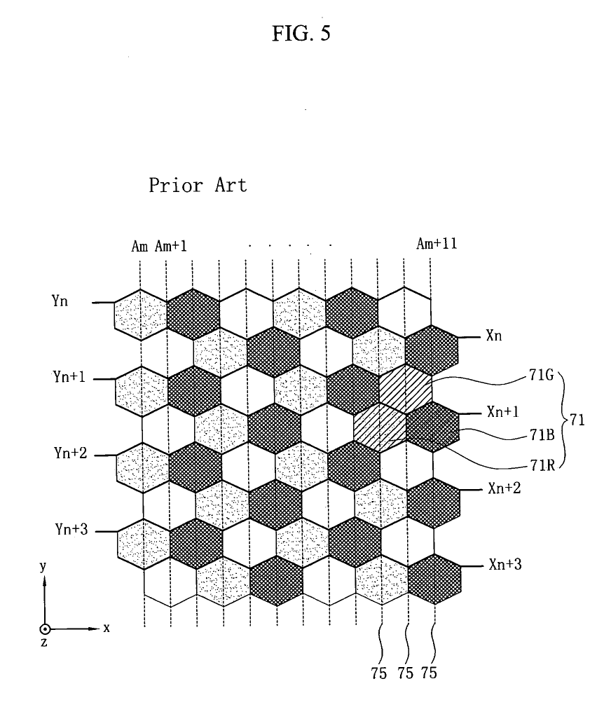

In the PDP illustrated in FIG. 1, eight address electrodes 15 may be employed to drive sixteen pixels 120 arranged in the illustrated 4×4 matrix pattern. In contrast, in the conventional PDP illustrated in FIG. 5, a total of twelve address electrodes 75 are required to drive sixteen pixels 71 arranged in a conventional matrix pattern. Therefore, in a PDP according to the present invention, the number of address electrodes per number of pixels may be reduced. That is, the number of address electrodes 15 is ⅔ the number of address electrodes 75 used in the conventional arrangement illustrated in FIG. 5. Therefore, since a PDP according to the first embodiment of the present invention may employ fewer address electrodes, the design of terminal portions of the address electrodes 15 may be simplified.

In addition, power consumption by the address electrodes 15 may be reduced by ⅓ in comparison with the conventional PDP. Furthermore, a peak power per address element that controls the address electrodes 15, e.g., a tape carrier package (TCP), etc., may be reduced by ⅓ compared to the conventional PDP.

In the above-described arrangement of pixels and electrodes, one and a half scan electrodes 34 correspond to each pixel 120, i.e., six scan electrodes 34 are employed to drive four rows of pixels 120. By comparison, in the conventional PDP illustrated in FIG. 5, four scan electrodes are required. However, since scan elements may be less expensive than address elements, a total cost of driving circuits in the PDP according to the first embodiment of the present invention may be reduced as compared to the conventional PDP illustrated in FIG. 5, even though the number of scan elements may be increased.

If a PDP according to the first embodiment of the present invention, were to be operated in the same manner as the conventional PDP illustrated in FIG. 5, the address electrodes 15 might need to be switched frequently in order to display a vertical line, i.e., column, of a single color. In particular, comparing FIG. 1 to FIG. 5, it is apparent that, in FIG. 1, subpixels of each color are arranged sequentially along a same address electrode 15, whereas, in FIG. 5, only subpixels of a single color correspond to each address electrode 75. Accordingly, if the scan electrodes Y are scanned sequentially, i.e., in the order of Yn+1, Yn+2, Yn+3, Yn+4, etc., and a display of a vertical line of a single color is desired, then the selected address electrodes 15 might need to be turned on and off frequently, i.e., turned on when the scan crosses the desired color subpixel, turned off when the scan crosses the subsequent two undesired subpixels, turned on for the next desired color subpixel, etc. Such an increase in the on/off switching of the address electrodes 15 might cause the address power consumption to increase. In contrast, in the conventional arrangement illustrated in FIG. 5, a desired address electrode 75 could be turned on and remain on while each scan electrode is sequentially scanned.

In order to reduce switching of the address electrodes 15 during the display of a vertical line of a single color, a PDP according to an embodiment of the present invention may be configured as described below.

Generally, referring to FIG. 1, the PDP may include scan electrode drivers 200 connected to the scan electrodes 34, sustain electrode drivers 300 connected to the sustain electrodes 32 and address electrode driver 400 connected to the address electrodes 15. During operation of the PDP, the scan electrode drivers 200 may control the application of scan signals to the scan electrodes 34 and the address electrode driver 400 may control the application of address signals to the address electrodes 15. Discharge cells 18 to be turned on may be selected by the scan and address signals. Subsequently, in order to maintain a discharge in the selected discharge cells 18 and display an image, the scan electrode drivers 200 may control the application of sustain signals to the scan electrodes 34 and the sustain electrode drivers 300 may control the application of sustain signals to the sustain electrodes 32.

As illustrated in FIG. 1, scan electrodes 34 that correspond to discharge cells 18 of a same color for a same address electrode 15 may each be connected to a same one of scan electrode drivers 210, 220 and 230. For example, the scan electrode drivers 200 may include a red scan electrode driver 210, a green scan electrode driver 220 and a blue scan electrode driver 230 corresponding to three colors of discharge cells 18.

For a same one of the scan electrode drivers 210, 220 and 230, the scan electrodes 34 connected thereto may correspond to every third scan line Y. That is, with respect to a same address electrode 15, the scan electrodes 34 corresponding to discharge cells 120 of a same color may be connected to one of the separate scan electrode drivers 210, 220 and 230, respectively. For example, the scan electrodes 34 labeled Yn+1, Yn+4, and Yn+7 may correspond to red discharge cells 120R along a same address electrode 15, may each be connected to the red scan electrode driver 210, and may be sequentially driven. Similarly, the scan electrodes 34 labeled Yn+2 and Yn+5 may correspond to green discharge cells 120G, may each be connected to the green scan electrode driver 220, and may be sequentially driven. Likewise, the scan electrodes 34 labeled Yn+3 and Yn+6 may correspond to blue discharge cells 120B, may be connected to the blue scan electrode driver 230, and may be sequentially driven.

Accordingly, when a same one of the scan electrode drivers 210, 220 and 230 sequentially generates scan signals, discharge cells 18 of one color along an address electrode 15 may be successively selected. Discharge cells 18 of another color may be selected thereafter by another of the scan drivers 210, 220 and 230. Thus, the number of switching instances of a same address element connected to the address electrode driver 400 may be reduced when a vertical line of single color is displayed. Therefore, by reducing switching, an increase of power consumption by the address electrodes may be prevented.

The sustain electrodes 32 may be driven in similar fashion to the scan electrodes 34. That is, sustain electrodes 32 corresponding to discharge cells 120 of same colors may be connected to separate sustain electrode drivers 310, 320 and 330, respectively. For example, referring to FIG. 1, the sustain electrodes 32 labeled Xn+1, Xn+4 and Xn+7 may correspond to the red discharge cells 120R and may be successively connected to the red scan electrode driver 310. Similarly, the sustain electrodes 32 labeled Xn+2 and Xn+5 may correspond to the green discharge cells 120G and may be successively connected to the green sustain electrode driver 320. Likewise, the sustain electrodes 32 labeled Xn+3 and Xn+6 may correspond to the blue discharge cells 120B and may be successively connected to the blue sustain electrode driver 330.

In the exemplary PDP illustrated in FIG. 1, the sustain electrodes 32 corresponding to discharge cells 120 of each color are connected to separate sustain electrode drivers. However, the sustain electrodes 32 may be connected to a common sustain electrode driver (not shown).

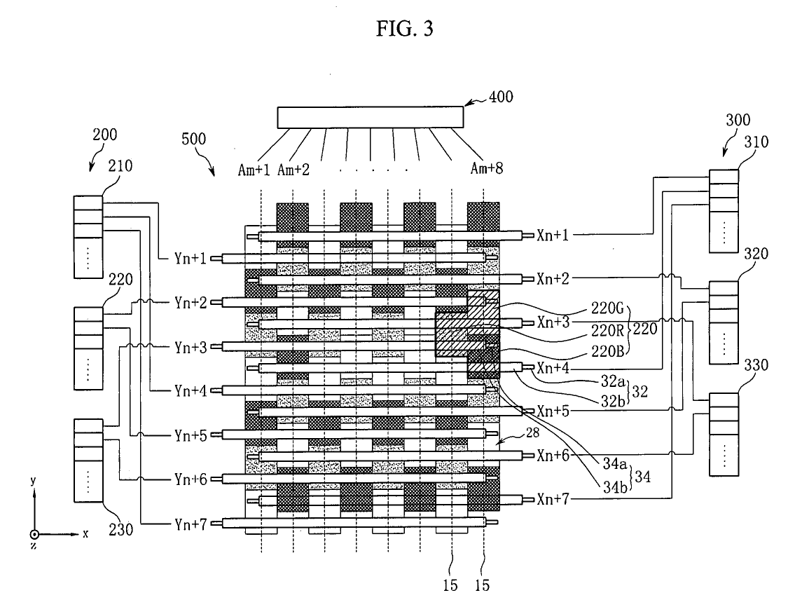

FIG. 3 illustrates a schematic diagram of an exemplary plasma display device according to a second embodiment of the present invention. The plasma display device illustrated in FIG. 3 may be substantially similar to that the plasma display device described above in the first embodiment of the present invention, but differing in the plan shape of subpixels 220R, 220G and 220B forming a pixel 220.

Referring to FIG. 3, subpixels 220R, 220G and 220B may be formed in, discharge cells 28 having a rectangular plan shape. As in the arrangement described above in connection with the first embodiment of the present invention, two of the subpixels 220R, 220G and 220B may correspond to a single address electrode, and the other of the subpixels 220R, 220G and 220B may correspond to a different address electrode. Additionally, the scan electrodes 34 and the sustain electrodes 32 may be arranged with respect to the pixels 220 in similar fashion to that described above in connection with the first embodiment of the present invention. Thus, it is apparent that the shape of the discharge cells may be modified in various ways.

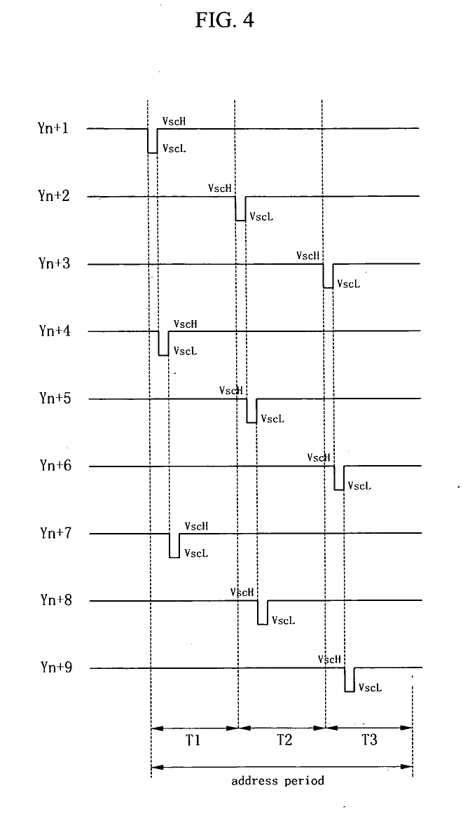

FIG. 4 illustrates a driving method of a plasma display device according to a third embodiment of the present invention. For convenience of explanation, FIG. 4 shows waveforms applied to a part of the scan electrodes 34 in the address period.

As described above, in a plasma display device according to exemplary embodiments of the present invention, subpixels of different colors may be alternately arranged with respect to a same address electrode 15 and, if the scan electrodes 34 were to be sequentially scanned, i.e., in the order of Yn+1, Yn+2, Yn+3, Yn+4 etc., the display a vertical line of a single color along the address electrode 15 might result in an increased number of switching instances for the address electrode 15. Therefore, the method of driving a plasma display device according to the third embodiment of the present invention may include first applying scan signals the scan electrodes 34 corresponding to discharge cells 18 of a particular color along an address electrode 15. Thereafter, scan signals may be applied to the scan electrodes 34 corresponding to discharge cells 18 of another color. In other words, scan signals may be applied close in time to the scan electrodes 34 corresponding to discharge cells 18 of same colors.

Referring to FIG. 4, in a first portion T1 of the address period, scan signals with voltage VscL may be sequentially applied to the scan electrodes Yn+1, Yn+4 and Yn+7. That is, referring to FIG. 1 with respect to the address electrode Am+2, the scan signals may be sequentially applied to the scan electrodes Yn+1, Yn+4 and Yn+7 corresponding to red discharge cells 120R (or 220R in FIG. 3) located along the address electrode Am+2.

Next, in a second portion T2 of the address period, scan signals with voltage VscL may be sequentially applied to the scan electrodes Yn+2, Yn+5 and Yn+8. That is, referring to FIG. 1 with respect to the address electrode Am+2, the scan signals may be sequentially applied to the scan electrodes Yn+2, Yn+5 and Yn+8 corresponding to green discharge cells 120G (or 220G in FIG. 3) located along the address electrode Am+2.

Next, in a third portion T3 of the address period, scan signals with voltage VscL may be sequentially applied to the scan electrodes Yn+3, Yn+6 and Yn+9. That is, referring to FIG. 1 with respect to the address electrode Am+2, the scan signals may be sequentially applied to the scan electrodes Yn+3, Yn+6 and Yn+9 corresponding to blue discharge cells 120B (or 220B in FIG. 3) located along the address electrode Am+2.

Each scan electrode 34 may be maintained at a voltage VscH higher than VscL when the scan signals are not applied to each scan electrode 34. Note that FIG. 4 illustrates scan signals descending in the negative direction. However, it should be understood that various waveforms may be applied to the scan electrodes 34 in order to select discharge cells 18 during the address period.

According to the third embodiment of the present invention, the scan signals that are applied to the scan electrodes 34 corresponding to discharge cells 18 of a same color with respect to a same address electrode may be applied close together in time. Thus, the number of switching instances of an address element may be reduced when a vertical line of a single color is displayed. In addition, as the switching numbers may be reduced, power consumption by the address electrodes 15 may be reduced.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display device, comprising:
a plasma display panel including:
a plurality of discharge cells defined between a front substrate and a rear substrate;
address electrodes proximate to the discharge cells and extending in a first direction; and
scan and sustain electrodes proximate to the discharge cells and extending in a second direction crossing the first direction,
wherein, for a same pixel, at least two discharge cells of different colors correspond to a same address electrode.

2. The plasma display device as claimed in claim 1, wherein centers of three discharge cells forming the same pixel are arranged in a triangular pattern, and
3/2 scan electrodes correspond to the pixel.

3. The plasma display device as claimed in claim 1, further comprising scan electrode drivers connected to the scan electrodes, wherein first scan electrodes corresponding to discharge cells of a same color along a same address electrode are connected to a same scan electrode driver.

4. The plasma display device as claimed in claim 3, wherein the scan and sustain electrodes are alternately arranged in the first direction, and
the first scan electrodes are arranged every three scan electrodes in the first direction.

5. The plasma display device as claimed in claim 3, wherein there are first, second and third colors of discharge cells and corresponding first, second and third scan electrode drivers.

6. The plasma display device as claimed in claim 3, wherein a same scan electrode driver is configured to apply scan signals to the first scan electrodes sequentially, such that discharge cells of a first color along the same address electrode are scanned before discharge cells of a second color along the same address electrode are scanned.

7. The plasma display device as claimed in claim 1, wherein a number Ai of address electrodes and a number Yj of scan electrodes in a p×p array of pixels satisfy Equation 1:
Ai:Yj=4:3 (1),
where p is a positive integer representing the number of pixels continuously arranged in the first or second direction.

8. The plasma display device as claimed in claim 7, wherein, for p=4, eight address electrodes and six scan electrodes drive all of the pixels in the p×p array of pixels.

9. The plasma display device as claimed in claim 1, wherein each of the discharge cells has a hexagonal plan shape.

10. The plasma display device as claimed in claim 1, wherein each of the discharge cells has a rectangular plan shape.

11. The plasma display device as claimed in claim 1, wherein a borderline between a pair of discharge cells that are adjacent along a same address electrode extends perpendicular to the address electrode.

12. The plasma display device as claimed in claim 1, wherein there are first, second and third colors of discharge cells and a same address electrode crosses near a center of a first discharge cell of the first color, near a center of a second discharge cell of the second color and a near a center of a third discharge cell of the third color in sequence.

13. The plasma display device as claimed in claim 12, wherein the first and second discharge cells are part of a same pixel, the third discharge cell is part of an adjacent pixel, the first discharge cell is crossed by a first scan electrode and the second discharge cell is crossed by a second scan electrode.

14. A method of driving a plasma display device, the plasma display device including address electrodes and scan electrodes configured to drive discharge cells in a pixel, wherein, in the pixel, discharge cells of a first color and discharge cells of a second color are disposed along a given address electrode, the method comprising:
applying scan signals to scan electrodes corresponding to discharge cells of the first color along the first address electrode during a first portion of an address period of the given address electrode; and
applying scan signals to scan electrodes corresponding to discharge cells of the second color along the first address electrode during a subsequent portion of the address period.

15. The method as claimed in claim 14, wherein the scan signals are sequentially applied to the scan electrodes corresponding to a same color along the given address electrode.

16. The method as claimed in claim 14, further comprising:
applying scan signals to scan electrodes corresponding to the discharge cells of a third color along the given address electrode during a third portion of the address period.

17. The method as claimed in claim 16, wherein the scan signals are sequentially applied to the scan electrodes corresponding to the third color.

18. The method as claimed in claim 14, wherein the plasma display device includes a plurality of scan electrodes that cross the given address electrode, and
scan signals are applied sequentially to every third scan electrode.

19. A plasma display panel, comprising:
an array of pixels, each pixel including three different colored subpixels; and
a plurality of address electrodes and a plurality of scan electrodes configured to drive the array, wherein each address electrode is configured to drive subpixels of each of the three different colors,
a same address electrode is configured to drive two different colored subpixels of a same pixel, and
a same scan electrode is configured to drive two different colored pixels of a same pixel.

20. The plasma display panel as claimed in claim 19, wherein, for a same pixel, each of the three subpixels are driven by one of two adjacent address electrodes and one of two adjacent scan electrodes.
